(19) United States
(12) Patent Application Publication
(10) Pub. No.: US 2020/0019225 A1
(43) Pub. Date: Jan. 16, 2020

(54) SYSTEM AND METHOD FOR PREVENTING ELECTRIC FIRE AND MONITORING FUNCTIONALITY OF FIRE HYDRANT AND SPRINKLER SYSTEM

(71) Applicant: ICICI LOMBARD General Insurance Company Ltd., Mumbai (IN)

(72) Inventors: Gaurav Arora, Parbhadevi (IN); Burzin Sarbhanwala, Parbhadevi (IN); Ihtishamuddin Khan, Parbhadevi (IN)

(21) Appl. No.: 16/507,325

(22) Filed: Jul. 10, 2019

(30) Foreign Application Priority Data
Jul. 10, 2018 (IN) 201821025755

(51) Int. Cl. G06F 1/3206; G06F 1/28; G06F 1/30; G06F 16/17; E03B 7/07; H04L 29/08

(52) U.S. Cl. CPC G06F 1/3206; G06F 1/28; H04L 67/025; G06F 16/1734; E03B 7/071; G06F 1/30

(57) ABSTRACT

The present invention relates to an electric fire safety system and a fire hydrant and sprinkler system and method implementation thereof. The system for preventing electric fire includes a plurality of units to capture voltage and current data of an electric supply, a power control unit (PCU) to provide the electric supply, and a central control unit (CCU) including a microcontroller, a sensor, a driver circuit and a communication module. The sensor and the driver circuit are configured to detect electric overload and fluctuations in the electric supply at the PCU and generate a signal. The communication module transmits the signal to a backend system configured to create an alert based on the signal. A hydrant and sprinkler system includes a plurality of pumps, a sensor configured to measure pressure at each of the plurality of pumps to respectively determine a status and generate a signal, and a communication module that transmits the generated signal to a backend system is configured to create an alert based on the signal.

### FIELD OF INVENTION

Embodiments of the present application illustrate a system and method for preventing electric fire and monitoring functionality of fire hydrant and sprinkler system.

### BACKGROUND

In the recent years, the evolution of IoT devices have provided exciting capabilities and services to the end user. The IoT devices and systems have been consistently improving and the use of such devices and systems have also been introduced in different technological areas such as to prevent unexpected mishaps caused by human error or malfunctioning of other devices. The evolution in the industry and an increased demand from consumers of different segments causes an increased influx of small industries to cater such need. With an increased influx of such industries, the fire hazards are also on the rise caused by various factors including but not restricted to short-circuit, electrical surge, increased load and/or untrained labor. Furthermore, a fluctuation in the incoming electricity also causes many devices to malfunction and it may cause sudden fire in the electrical wiring or fittings installed.

To prevent fire hazards, various measures had been taken by the civil agencies wherein fire-fighting instruments have been installed for preventing and putting-off such hazards. However, the fire-fighting devices such as fire hydrant and sprinkler system often does not work properly due to large maintenance they require for the proper functioning. Further, there is no such device to monitor the state of such fire-fighting system, on a real-time basis, to enable proper functioning of the device at the time of fire-hazards. Therefore, in the event of such fire-hazards, the non-working of such device causes huge losses and thereby increases the burden on small industries and impacts the economy also.

Therefore, there is a need of an advanced technology to plan, manage, monitor, and control electricity delivery that are needed to enable safe and reliable systems. There is also a need to monitor the proper functioning of the fire hydrant and sprinkler systems so as to use the system effectively during a fire-hazard.

### SUMMARY

The following presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter.

In order to overcome the problems as discussed above, a system for preventing electric fire is disclosed, wherein the system comprises a plurality of units to capture voltage and current data of an electric supply. Further, the system comprises a power control unit (PCU), wherein the PCU comprises of a contactor switch and is configured to provide the electric supply to a current transformer and a potential transformer. Further, the system also comprises a central control unit (CCU), wherein the CCU comprises of a microcontroller, a sensor, a driver circuit and a communication module. The sensor and the driver circuit are configured to detect electric overload and fluctuations in the electric supply at the PCU and generate a driver signal. Further, the communication module is in communication with the CCU to transmit the driver signal to a remote unit/backend system, wherein the remote unit/backend system is configured to create an alert signal based on the driver signal. Further, the sensor is in communication with the microcontroller and is configured to store the driver signal in a memory and processing the driver signal.

Embodiments of the invention also provide combination of IoT based hardware devices with backend system powered by self-learning methods. The embodiments eliminate further damage and also keep a log of anomalies. The self-learning system and methods will also help in evaluating the responsiveness towards rectifying the electrical issues.

It is also provided that the CCU is configured to provide an auxiliary voltage to the power control unit based on the driver signal. In addition, the remote unit comprises a database to keep a log of the driver signal and is configured to generating a report for a user based on the driver signal for a specified period of time. Further, the system also comprises a web based dashboard to display reports for an establishment of the user based on the driver signal for the establishment.

Embodiments of the present application provide a hardware set up of capturing voltage data, current data and load data in either single phase supply or three phase supply. Embodiments of the present invention further provide different IoT devices for capturing the inputs through sensors, transmitting such inputs for collecting and processing data to a cloud server or remote unit and generating alert signal and reports and transmitting such report to a user via a communication network by SMS, email or on a Website-based dashboard. Further, the plurality of units and the sensor of the system, as provided in the present invention, are Internet of Things (IoT) enabled.

Embodiments of the present invention further provide a communication module to the circuit breaking device for transmitting alerts and logging the electric data on to a cloud system that is accessible to anyone with login credentials and an internet connection. Further, the present invention also provides a method or process which categorizes the client on the basis of responsiveness towards the alerts and rectification using the data shared on the cloud.

Embodiments of the present invention provides a sensor and an alert-cum-analytics backend system. The sensor detects the electrical overloads and incoming voltage surges and controls that by tripping at defined threshold. Basically, the device checks the historical usage and pattern and any anomaly going above the historical usage pattern will activate the method to cut of the electrical supply. The sensor is fitted with a communication gateway for transmitting the collected data to a backend system. The backend system processes the collected data, transmits SMS and email based alerts and keeps a log of data and displays it on a website based dashboard. Embodiment of the present invention are also configured to auto cut-off electricity at defined time intervals.

In an alternate embodiment of the invention, a method for preventing electric fire is disclosed, the method comprises capturing voltage and current data of an electric supply where the electric supply is provided to a current transformer and a potential transformer. Subsequently, electric overload and fluctuations are detected in the electric supply, and then generating a driver signal. Consequently, the signal is transmitted and an alert signal is created based on the driver signal.

An alternative embodiment of the present invention provide an IoT enabled hydrant control system and a method wherein a hardware is set up for capturing pressure (low or high) and for the functioning of jockey pump and main pump.

In another embodiment of the invention, a hydrant and sprinkler system are disclosed, wherein the system comprises a plurality of pumps, a sensor and a communication module. The sensor provided by the invention is configured to measure pressure at each of the plurality of pumps, determine a status of each of the plurality of pumps and generate a sensor signal for each of the plurality of pumps. Further, the communication module transmits said sensor signal to a remote unit, wherein the remote unit is configured to create an alert signal based on said sensor signal.

It is provided by the invention that said sensor signal comprise a plurality of parameters including leakage of water, water availability, pressure adequacy and unauthorized usage of water. Further, the status of the pump may include ON, OFF or TRIP.

Embodiments of the present invention further provide different IoT devices for capturing the inputs through sensors, transmitting such inputs for collecting and processing data to a cloud server and generating alerts and reports and transmitting such report to a user via a communication network by SMS, email or on a Web dashboard which represents pressure adequacy and functional status of pumps.

In an embodiment of the invention, the remote unit comprises a database to keep a log of the sensor signal and is configured to generate a report for a user based on the sensor signal for a specified period of time and transmit the report to the user via a communication network by SMS, email or on a web based dashboard. Further, the system is also configured to indicate the location of the user in real time, generate a report for the user based on events identified from the sensor signal and the location of the user for the specified period of time and transmit the report to a user via a communication network by SMS, email or on a web based dashboard. Further, the plurality of pumps and the sensor of the system, as provided in the present invention, are Internet of Things (IoT) enabled and configured to access internet. Further, the plurality of pumps include a plurality of jockey pumps and a main pump, where the main pump provides the pressure in an outlet supplying water to the plurality of jockey pumps.

In an alternate embodiment of the invention, a method for monitoring a hydrant and sprinkler system is disclosed, wherein the method comprises measuring the pressure at a plurality of pumps, determining the status of the plurality of pumps and generating a sensor signal, transmitting said sensor signal to a remote unit, and creating an alert signal based on said sensor signal.

### BRIEF DESCRIPTION OF FIGURES

The detailed description is described with reference to the accompanying FIGURES.

FIG. 1 illustrates a diagrammatic representation of the system of the present disclosure.

### DETAILED DESCRIPTION

The following discussion provides a brief, general description of the invention which provides a system and a method for preventing electric fire. The embodiments described herein can be practiced with other system configurations, including Internet appliances, hand held devices, multi-processor systems, microprocessor based or programmable consumer electronics, network PCs, mini computers, mainframe computers and the like. The embodiments can be embodied in a special purpose processor to perform one or more of the mechanisms explained in detail below.

Exemplary embodiments now will be described with reference to the accompanying drawings. The disclosure may, however, be embodied in many different forms and should not be construed as limited to the embodiments set forth herein; rather, these embodiments are provided so that this disclosure will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The FIGURES depict a simplified structure only showing some elements and functional entities, all being logical units whose implementation may differ from what is shown. The connections shown are logical connections; the actual physical connections may be different. It is apparent to a person skilled in the art that the structure may also comprise other functions and structures. It should be appreciated that the functions, structures, elements and the protocols used in communication are irrelevant to the present disclosure. Therefore, they need not be discussed in more detail here.

In addition, all logical units described and depicted in the FIGURES include the software and/or hardware components required for the unit to function. Further, each unit may comprise within itself one or more components, which are implicitly understood. These components may be operatively coupled to each other and be configured to communicate with each other to perform the function of the said unit.

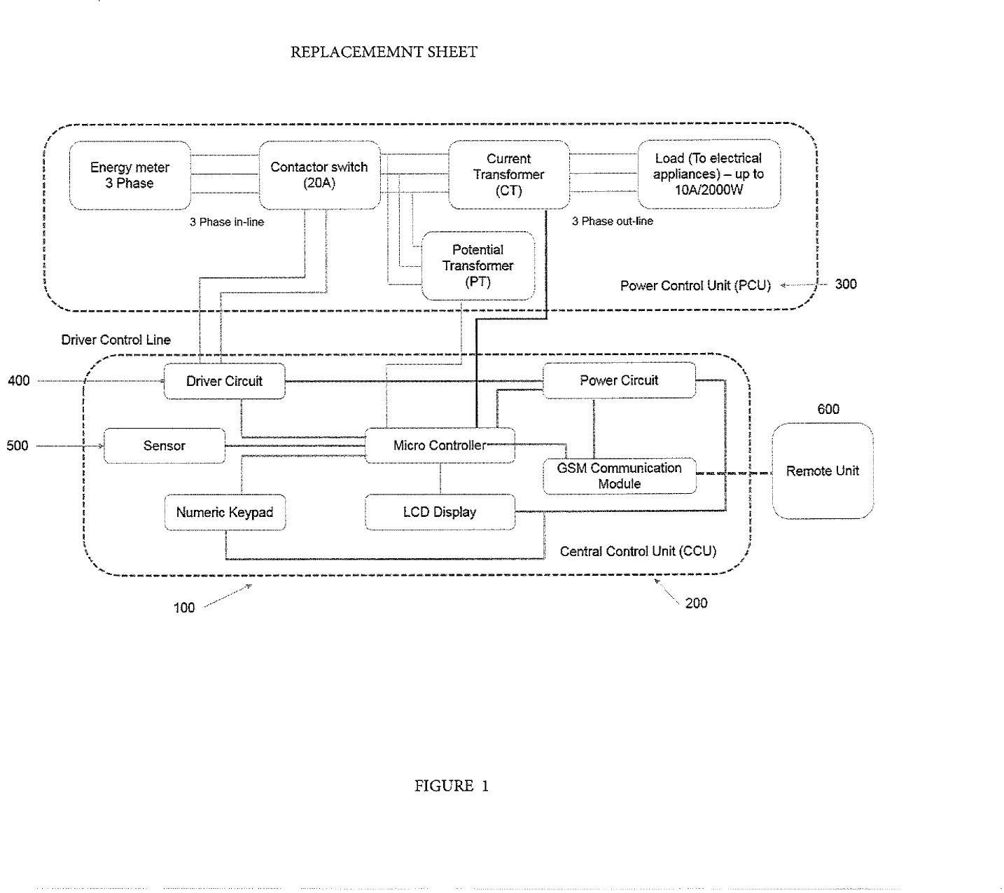

FIG. 1 of the disclosure illustrates a diagrammatic representation of a system according to an embodiment of the present disclosure.

According to an embodiment of the disclosure, a system 100 contains different units for capturing voltage data, current data and load data in either single phase supply or three phase supply. The system 100 is provided for preventing electric fire in a site or shop or establishment that is administered by a user. The system (100) comprises of a Power Control Unit, “PCU”, (300) and a Central Control Unit “CCU”, (200). The PCU (300) and CCU (200) are connected with each other through a Driver Control Line (DCL). The CCU (200) consists of different IoT devices used for capturing the inputs through sensors, transmitting such inputs for collecting and processing data to a cloud server (600) and generating alerts and reports and transmitting such report to a user via a communication network by SMS, email or on a Web dashboard.

The CCU (200) further comprises of a Driver Circuit, a Power Circuit, a Microcontroller, a Communication device, a display and an input unit.

The PCU (300) consists of a contactor switch through which the electric power supply is fed to the current transformer, potential transformer and to the driver circuit of the CCU (200).

The potential transformer provides negligible load to the supply being measured and have an accurate voltage ratio and phase relationship which provides accurate secondary connected metering. The electricity is also provided to a current transformer which produces an alternating current in its secondary winding which is proportional to the current being measured in its primary. The current transformer reduces high voltage currents to a lower value and provide an appropriate load as desired by the user of the system. The potential transformer output and the current transformer output has also been provided to the microcontroller in the CCU (200). A voltage sensor (500) and a current sensor (500) are used to detect the flow of the voltage and current and any fluctuations in the electric supply.

The sensor and the driver circuit detect electric overload and fluctuations in the electric supply at the PCU (300), which is followed by generation of a signal. The communication module transmits signal to a remote unit (600) that processes the signal to create an alert for the user to take decisive action in case of emergent situation at said site/shop/establishment. The remote unit (600) can also be considered as a cloud server implemented on platforms like Amazon Web Services®, Google Cloud Platform®, Microsoft Azure®, IBM Bluemix®, Alibaba Cloud®.

In CCU (200), the driver circuit supplies the electric supply to the microcontroller and to the Power circuit wherein the driver circuit detects malfunctions, storing and reporting failures to the microcontroller and analyze sensor signals, and creating auxiliary voltages. The power circuit provides the necessary voltage for operating the different modules of the CCU (200) such as Microcontroller, Communication module, input unit and a display. The sensor detects the electrical overloads and incoming voltage surges and controls that by tripping at threshold defined by historical usage and pattern of particular location. The sensor (500) is fitted with a communication gateway for transmitting the collected data to a backend system.

Said signal comprise captured data from multiple units and information regarding multiple fault events including electric overload and fluctuations from IoT enabled sensors and driver circuit as discussed above. In case the signal indicates that any of the fault events has occurred, the CCU (200) supplies an auxiliary voltage to the PCU (300) till subsistence of the fault event. The cloud server is also connected with a database to maintain a repository of fault events detected by the CCU (200) of the system (100), where the database may include MySQL®, Microsoft Access®. The cloud server processes the signal and stores to the database the information about the fault events included in the signal for a period of time, where the period of time refers to time of occurring fault events. The data including fault events for detected time period may be indexed in above database platform.

The system comprises of PCU (300) and CCU (200) which are connected via a communication network to a cloud server which monitors and processes the collected data, transmit said data or an alert signal based on said data by a SMS and/or by an email and keeps a log of data and displays it on a website based dashboard. The system is also configured to auto cut-off electricity at defined time intervals.

Further, the web dashboard of the present invention is accessible only to the authorized user of the system wherein various features are provided to the user. The web dashboard is accessible on a mobile phone also having capabilities to connect to an internet network. The user of the system can access the history of the logs stored by the system and thus, program the system to ON-OFF for a particular time interval. The web dashboard presents different reports in the forms of different graphs to the user of the system. Specifically, the web dashboard is configured to display alerts and reports of the data shared with cloud server corresponding to a time period selected by the user. The web dashboard is configured to display time selection element which will enable the user to select time interval for which user desire to view alerts and reports. The system (100) is further capable of combining different industrial/shop establishments of a user into one account for representing the reports collected by the system for the corresponding locations.

In the form of graphical representations, for the different locations, the alerts generated of a particular duration or the data of overload, surge and fluctuations can be generated for a detailed analysis and therefore preventive measures can be taken by the user of the system.

In another embodiment of the present invention an IoT enabled hydrant and sprinkler control system and a method is provided wherein a hardware is set up of capturing pressure (low or high), functioning of jockey pump and main pump are provided.

The sensors installed in the user location are enabled to measure the pressure of the water in the hydrant and sprinkler system and are also configured to check the proper functioning of the main pump and the jockey pump. With the configuration of the sensors and the other hardware equipment, the user is enabled to check the leakages of the water in the hydrant and sprinkler system, pressure, availability of the water in the system and functional status (On/Off/Trip) of both jockey and main pump.

Said sensor is also configured to generate a sensor signal for each of the plurality of pumps, where the sensor signal is generated based on measured pressure and said functional status and comprise plurality of parameters including leakage of water, water availability, pressure adequacy and unauthorized usage of water. Further, the system also comprises a communication module to transmit the sensor signal for each of the plurality of pumps to a remote unit. On receiving the signal, the remote unit creates an alert signal based on the value of parameters included in sensor signal.

The remote unit can also be considered as a cloud server implemented on platforms like Amazon Web Services®, Google Cloud Platform®, Microsoft Azure®, IBM Bluemix®, Alibaba Cloud®. The cloud server processes the sensor signal and stores to the database the plurality of parameters included in the sensor signal for a specified period of time, where the period of time refers to time of determining the plurality of parameters by the sensor.

The design of the system requires minimal wiring and minimal space. The system is further capable of indicating the status of the user location on real-time basis and provide a detailed report for the analysis of the events occurred in a defined period of time as desired by the user of the system.

Further, the user is provided with a dedicated dashboard which represents the events and the history of the data captured by the system of the user's location(s). The interface of the system is accessible on a laptop and/or on compact handheld device connected to internet.

Further, different IoT devices capture the inputs through sensors and transmit such inputs for collecting and processing data to a cloud server. Every user of the system is provided with a distinct login id for viewing the dashboard wherein the corresponding user can generate reports which represents pressure adequacy, availability of water, leakages, unauthorized water usage and status of jockey and main pump.

In accordance with another embodiment of the present invention, there is provided a method for monitoring the hydrant and sprinkler system installed at a site/establishment/shop/manufacturing unit administered by a user. Said method comprises measuring pressure value available at a plurality of pumps which is used to indicate proper functioning of said plurality of pumps depending on type of pumps, wherein the plurality of pumps includes a plurality of jockey pumps meant for maintaining pressure for an outlet for releasing water on detecting fire and the main pump provide pressure for an outlet meant for supplying water to the plurality of jockey pumps. Further, the method comprises determining a functional status of said plurality of pumps, wherein the functional status may include ON, OFF or TRIP. Further, a sensor signal is generated to be transmitted to a remote unit, wherein said sensor signal comprise plurality of parameters including leakage of water, water availability, pressure adequacy and unauthorized usage of water. Further, the signal may also include standard operating procedure data for the plurality of pumps.

On receiving the signal, the remote unit creates an alert based on the value of parameters included in said sensor signal. The remote unit can also be considered as a cloud server implemented on platforms like Amazon Web Services®, Google Cloud Platform®, Microsoft Azure®, IBM Bluemix®, Alibaba Cloud®. Further, the remote unit is configured to generate a report for a user, in response to receiving a request from the user for a user elected time period, based on said sensor signal corresponding to the user selected time period

Whereas the user may request to view alerts and/or reports for previous detection period of time. Accordingly, the cloud server transmits the alert signal and report for the period of time as specified by the user. The method, provided by the invention, comprises indicating a location of the user in real time and generating report based on the signal and the location of the user. Further, the alerts and reports are transmitted to the user via a communication network by SMS, email or other configured messaging service.

As will be appreciated by one of skill in the art, the present invention may take the form of an entirely hardware embodiment or an embodiment combining software and hardware aspects all generally referred to herein as an apparatus and a method.

Furthermore, the present invention was described in part above with reference to flowchart illustrations and/or block diagrams of methods, apparatus (systems), and computer program products according to embodiments of the invention.

It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

Instructions may also be loaded onto a computer or other programmable data processing apparatus like a scanner/check scanner to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It should also be noted that in other implementations, the function(s) noted in the blocks may occur out of the order noted in the FIGURES. For example, two blocks shown in succession may, in fact, be executed substantially concurrently or the blocks may sometimes be executed in the reverse order, depending on the functionality involved.

In the drawings and specification, there have been disclosed exemplary embodiments of the invention. Although specific terms are employed, they are used in a generic and descriptive sense only and not for purposes of limitation.

1. A system for preventing electric fire in an establishment, the system comprising:
a plurality of units to capture voltage and current data of an electric supply;
a power control unit (PCU), wherein the PCU comprises of a contactor switch and is configured to provide the electric supply to a current transformer and a potential transformer;
a central control unit (CCU), wherein the CCU comprises of:
a microcontroller,
a sensor,
a driver circuit, wherein the sensor and the driver circuit are configured to detect electric overload and fluctuations in the electric supply at the PCU and generate a driver signal, and
a communication module in communication with the CCU to transmit the driver signal to a remote unit, wherein the remote unit is configured to create an alert signal based on the driver signal.

2. The system as claimed in claim 1, wherein the microcontroller is configured to store the driver signal and the alert signal in a memory, and process the driver signal.

3. The system as claimed in claim 1, wherein the remote unit comprises a database to keep a log of the driver signal received by the remote unit and is configured to generate a report for a user based on the driver signal for a specified period of time.

4. The system as claimed in claim 1, wherein the CCU is configured to provide an auxiliary voltage to the PCU based on the driver signal and tripping the electric supply at a threshold, and wherein the threshold is determined based on historical usage and pattern.

5. The system as claimed in claim 4, wherein the system comprises a web based dashboard to display reports for an establishment of a user based on the alert signal for the establishment corresponding to the specified period of time.

6. The system as claimed in claim 4, wherein the remote unit is configured to transmit the alert signal and the report corresponding to the specified period of time to the user via a communication network.

7. The system as claimed in claim 1, wherein the plurality of units and the sensor are Internet of Things (IoT) enabled.

8. A method for preventing electric fire in an establishment, the method comprising:
capturing voltage and current data of an electric supply;
providing the electric supply to a current transformer and a potential transformer;
detecting electric overload and fluctuations in the electric supply and generating a driver signal;
transmitting the driver signal; and
creating an alert signal based on the driver signal.

9. The method as claimed in claim 8, wherein the method further comprises:
keeping a log of the driver signal and the alert signal; and
generating a report for a user based on the driver signal for a specified period of time.

10. The method as claimed in claim 9, wherein the method further comprises providing an auxiliary voltage to a power control unit based on the driver signal and tripping the electric supply at a threshold, wherein the threshold is determined based on historical usage and pattern.

11. The method as claimed in claim 10, wherein the method further comprises displaying reports for an establishment of the user on a web based dashboard based on the driver signal for the establishment corresponding to the specified period of time.

12. The method as claimed in claim 10, wherein the method further comprises transmitting the alert signal and the report corresponding to the specified period of time to a user via a communication network.

13. A hydrant and sprinkler system, the system comprising:
a plurality of pumps for supplying water;
a sensor configured to measure pressure at each of the plurality of pumps, determine a status of each of the plurality of pumps, and generate a sensor signal for each of the plurality of pumps; and
a communication module configured to transmit the sensor signal to a remote unit,
wherein the remote unit is configured to create an alert signal based on the sensor signal.

14. The system as claimed in claim 13, wherein the sensor signal comprises a plurality of parameters including leakage of water, water availability, pressure adequacy and unauthorized usage of water.

15. The system as claimed in claim 14, wherein the status includes ON, OFF or TRIP.

16. The system as claimed in claim 15, wherein the remote unit comprises a database to keep a log of the sensor signal, and wherein the remote unit is configured to generate a report for a user based on the sensor signal for a specified period of time and transmit the report to a user via a communication network.

17. The system as claimed in 15, wherein the system is configured to indicate location of the user in real time, generate a report for a user based on the sensor signal and the location of the user for a specified period of time, and transmit the report to the user via a communication network.

18. The system as claimed in claim 13, wherein the plurality of pumps and the sensor are IoT enabled.

19. The system as claimed in claim 13, wherein the plurality of pumps includes a plurality of jockey pumps and a main pump.

20. A method for monitoring a hydrant and sprinkler system, the method comprising:
measuring the pressure at a plurality of pumps;
determining a status of the plurality of pumps and generating a sensor signal;
transmitting the sensor signal to a remote unit; and
creating an alert signal based on the sensor signal.

21. The method as claimed in claim 20, wherein the sensor signal comprises a plurality of parameters indicating leakage of water, water availability, pressure adequacy and unauthorized usage of water.

22. The method as claimed in claim 21, wherein the status includes ON, OFF or TRIP.

23. The method as claimed in claim 22, wherein the method further comprises keeping a log of the sensor signal, generating a report for a user based on the sensor signal for a specified period of time, and transmitting the report to the user via a communication network.

24. The method as claimed in 23, wherein the method further comprises indicating a location of the user in real time, generating a report for the user based on the sensor signal and the location of the user for a specified period of time, and transmitting the report to the user via a communication network.

25. The method as claimed in claim 20, wherein the plurality of pumps and the sensor are IoT enabled.

26. The method as claimed in claim 20, wherein the plurality of pumps includes a plurality of jockey pumps and a main pump.
